(19) United States
(12) Patent Application Publication
(10) Pub. No.: US 2023/0343989 A1
(43) Pub. Date: Oct. 26, 2023

(54) Manufacturing Method Of Battery Cell And Pouch Forming Apparatus

(71) Applicant: LG Energy Solution, Ltd., Seoul (KR)

(72) Inventors: Sung Chul Park, Daejeon (KR); Eung Jin Jang, Daejeon (KR); Sin Young Park, Daejeon (KR); Dong Hyeuk Park, Daejeon (KR)

(73) Assignee: LG Energy Solution, Ltd., Seoul (KR)

(21) Appl. No.: 17/918,665

(22) PCT Filed: Sep. 29, 2021
(86) PCT No.: PCT/KR2021/013331

§ 371 Date: Oct. 13, 2022

(30) Foreign Application Priority Data
Nov. 26, 2020 (KR) 10-2020-0161173

(51) Int. Cl. H01M 10/04

(52) U.S. Cl. CPC H01M 10/0477; H01M 10/0404; H01M 10/0481

(57) ABSTRACT

A method of manufacturing a pouch type battery cell according to an embodiment of the present disclosure includes forming an embossing part in a part of a pouch film by using an embossing punch part. A pouch forming apparatus for forming a receiving part of the pouch film includes an embossing punch part, a die part serving as a passage through which the punch part moves, and a blank holder in contact with the embossing punch part in the die part.

### CROSS-REFERENCE TO THE RELATED APPLICATIONS

The present application is a national phase entry under 35 U.S.C. § 371 of the International Application No. PCT/KR2021/013331 filed on Sep. 29, 2021, which claims priority from Korean Patent Application No. 10-2020-0161173 filed on Nov. 26, 2020, the disclosures of which are incorporated herein by reference in their entireties.

### FIELD OF THE INVENTION

The present disclosure relates to a manufacturing method of a battery cell and a pouch forming apparatus, and more particularly, to a manufacturing method of a battery cell having improved visual recognition rate and a pouch forming apparatus.

### BACKGROUND OF THE INVENTION

As the demands for portable electronic products such as notebooks, video cameras and cellular phones are rapidly increased in these days, and development of electric vehicles, energy storage batteries, robots, satellites, etc. is under active progress, numerous studies are being made on secondary batteries being used as the driving power source.

The electrode assembly mounted in the battery case is a power generating element, having a cathode/separator/anode stack structure, which can be charged and discharged, and the electrode assembly is classified into a jelly-roll type, a stacked type and a stacked/folded type. The jelly-roll type electrode assembly is configured to have a structure in which a long sheet type cathode and a long sheet type anode, to which active materials are applied, are wound in a state where a separator is interposed between the cathode and the anode, the stacked type electrode assembly is configured to have a structure in which a large number of cathodes having a predetermined size and a large number of anodes having a predetermined size are sequentially stacked in a state in which separators are interposed between the cathodes and the anodes, and the stacked/folded type electrode assembly is a combination of the jelly-roll type electrode assembly and the stacked type electrode assembly. Among them, the jelly-roll type electrode assembly has advantages in that manufacturing is easy and an energy density per unit weight is high.

Meanwhile, based on the shape of a battery case, a secondary battery is classified into a cylindrical battery where an electrode assembly is built into a cylindrical metal can, a prismatic battery where an electrode assembly is built into a prismatic metal can, and a pouch-type battery where an electrode assembly is built into a pouch type case formed of an aluminum laminate sheet.

A pouch-type secondary battery includes an electrode assembly in which an electrode and a separator are alternately laminated, and a pouch case for housing the electrode assembly. The method for manufacturing the secondary battery includes an electrode production step of producing an electrode, an electrode assembly production step of alternately laminating electrodes and a separator to produce an electrode assembly, an electrode lead coupling step of coupling electrode lead to the electrode assembly, and a pouch sealing step of housing the electrode assembly in a pouch case in a state where the tip of the electrode lead is pulled out to the outside, and sealing the edge surface of the pouch case.

Here, the pouch case is manufactured using a pouch forming apparatus, and the pouch forming apparatus includes a die unit in which a pouch film is disposed and a forming groove is formed, and a pressing unit in which the pouch film is inserted into the forming groove in a state where the pouch film disposed on the die unit is pressed, thereby forming an electrode assembly-receiving part. The pressing unit includes a pressing part inserted into the forming groove.

By using such a pouch forming apparatus, a pouch film is arranged on a die unit, and then the surface of the pouch film arranged on the die unit is pressed with the pressing part included in the pressing unit. Then, the pressing part is inserted into the forming groove of the die unit in a state where the pressing part presses the pouch film, whereby an electrode assembly-receiving part having the shape of the forming groove may be formed on the surface of the pouch film.

After that, in order to put the pouch film in a post-process, conventionally, the position could be specified by piercing the end part of the pouch film. However, when holes are formed in the pouch film by a piercing process, there are cases where holes cannot be pierced intermittently, which causes a problem that it becomes necessary to adjust the separate position of the piercing unit when changing the mold of the forming apparatus.

### DETAILED DESCRIPTION OF THE INVENTION

It is an object of the present disclosure to provide a manufacturing method of a battery cell having improved visual recognition rate and a pouch forming apparatus.

However, the problem to be solved by embodiments of the present disclosure is not limited to the above-described problems, and can be variously expanded within the scope of the technical idea included in the present disclosure.

According to an embodiment of the present disclosure, there is provided a method of manufacturing a pouch type battery cell, comprising: forming an embossing part in a part of a pouch film by using an embossing punch part.

The embossing punch part may be punched along an edge of the embossing part to form a recessed part.

The embossing part may be subjected to visual recognition as an inner circular shape and an outer circular shape based on the punched recessed part.

The forming the embossing part may further include forming a pouch film in a state where the embossing punch part and a blank holder are opposed to each other within a die part serving as a passage through which the embossing punch part moves.

The forming the embossing part may further include punching the pouch film by the embossing punch part while the blank holder presses the bottom surface in contact with the embossing part.

The bottom surface of the embossing part may be formed to be flat.

The embossing part may be formed during pouch forming of the pouch type battery cell.

According to an embodiment of the present disclosure, there is provided a pouch forming apparatus for forming a receiving part of the pouch film, the apparatus comprising: an embossing punch part, a die part serving as a passage through which the punch part moves; and a blank holder opposed to the embossing punch part in the die part.

The embossing punch part may form an embossing part having a recessed part in the pouch film, and an outer circular shape and an inner circular shape of the embossing part may be formed by a recessed part.

The blank holder may press the bottom surface of the pouch film in contact with the embossing part so that the bottom surface of the embossing part is flat.

According to embodiments of the present disclosure, it is possible to improve the visual recognition rate by applying an embossing process.

In addition, the pouch film is formed in a state where the embossing punch part and the blank holder are opposed to each other, so that the bottom surface of the pouch film in contact with the blank holder is flat, and the visual recognition rate can be further improved.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is an exploded perspective view showing a pouch type battery cell;

FIG. 2 is a view showing an embossing part formed by the method of manufacturing a pouch type battery cell according to an embodiment of the present disclosure;

FIG. 3 is a view showing an embossing forming unit according to an embodiment of the present disclosure;

FIG. 4 is a photograph showing an embossing part formed by an embossing process according to a comparative example;

FIG. 5 is a view showing a visual recognition rate of the embossing part of FIG. 4,

FIG. 6 is a photograph showing an embossing part formed by an embossing process according to an embodiment of the present disclosure; and

FIG. 7 is a view showing a visual recognition rate of the embossing part of FIG. 6.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

A description of parts not related to the description will be omitted herein for clarity, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

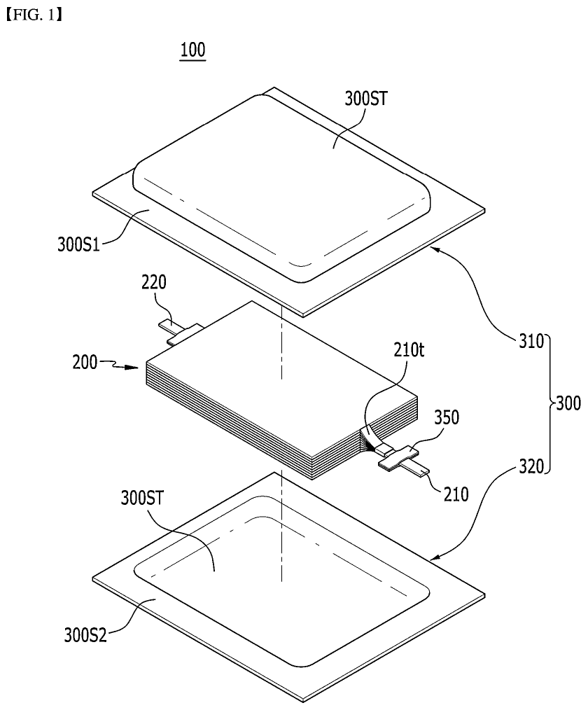

FIG. 1 is an exploded perspective view showing a pouch type battery cell.

Referring to FIG. 1, the pouch type battery cell 100 may be manufactured by housing an electrode assembly 200 inside a cell case 300 and then sealing the case. The electrode assembly 200 may include a positive electrode, a negative electrode, and a separator disposed between the positive electrode and the negative electrode. The electrode assembly 200 may be a stack type electrode assembly, a jelly-roll type electrode assembly, or a stack/folding type electrode assembly.

Each of the positive electrode and the negative electrode includes an electrode tab 210t, and the electrode leads 210 and 220 each connected to the electrode tab 210t may be exposed to the outside of the cell case 300. The electrode tab 210t may be formed by extending a foil of an electrode sheet included in the electrode assembly 200. In addition, the electrode leads 210 and 220 can be located respectively in the sealing part 300S1 and 300S2 in a state of being covered with a lead film 350 so as to secure a sealing property and an insulation property.

The cell case 300 is composed of a laminate sheet, and may include a resin layer for heat fusion and a metal layer for preventing material penetration. The cell case 300 may include an upper case 310 and a lower case 320.

Concave-shaped receiving parts 300ST on which the electrode assembly 200 can be seated may be formed in each of the upper case 310 and the lower case 320. Sealing parts 300S1 and 300S2 can be provided along the outer periphery of the receiving parts 300ST of the upper case 310 and the lower case 320, respectively. The sealing part 300S1 of the upper case 310 and the sealing part 300S2 of the lower case 320 can be heat-fused to each other to form a sealing part and seal the cell case 300.

In another embodiment of the present disclosure, one side of the upper case and one side of the lower case can be integrally connected to each other, and the remaining three sides can be heat-fused. Further, the receiving part 300ST may be formed only in any one of the upper case 310 and the lower case 320, and the other case may have a planar shape.

The cell case 300 described above can include a resin layer, a metal layer, a packaging sheet layer or the like to protect the pouch-type secondary battery. For this purpose, a process of forming a pouch film is required.

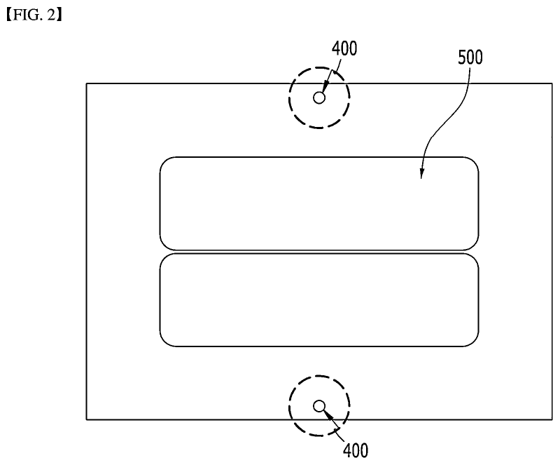

FIG. 2 is a view showing an embossing part formed by the method of manufacturing a pouch type battery cell according to an embodiment of the present disclosure.

By using such a pouch forming apparatus, a pouch film is arranged on a die unit, and then the surface of the pouch film arranged on the die unit is pressed with a pressing part included in the pressing unit. Then, the pressing part is inserted into a forming groove of the die unit in a state where the pressing part presses the pouch film, whereby the electrode assembly-receiving part 500 having the shape of the forming groove may be formed on the surface of the pouch film.

After that, in order to put the pouch film in a post-process, an embossing part 400 may be formed at the end part of the pouch film by using an embossing process as shown in FIG. 2. Specifically, the post-process refers to forming a pouch supplied to a roll during the battery packaging process, then placing the electrode assembly in the pouch, subjecting to a sealing process, and allowing the pouch cut into a sheet to be seated on the nest. At this time, the shape of the embossing part 400 may be recognized in order for the pouch to be accurately seated on the nest, and then automatic correction may be performed. The embossing part 400 according to the present embodiment may be formed during pouch forming.

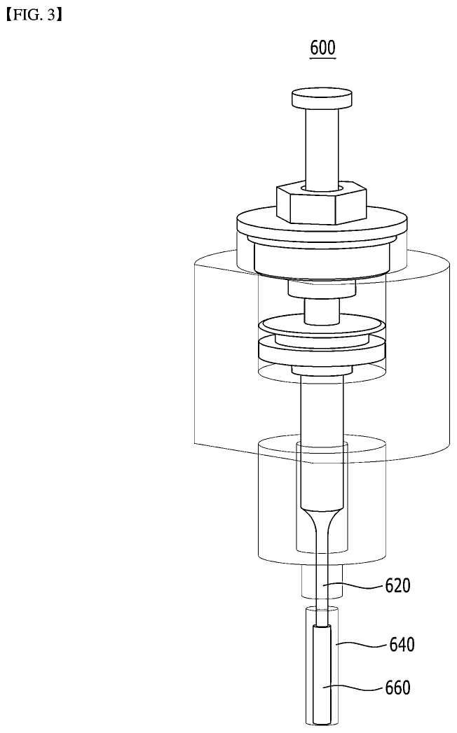

FIG. 3 is a view showing an embossing forming unit according to an embodiment of the present disclosure.

Referring to FIG. 3, in order to form the embossing part according to the present embodiment, the embossing punch unit 600 included in the pouch forming apparatus can be used. The embossing punch unit 600 may include an embossing punch part 620 for forming a recessed part of the embossing part 400 of FIG. 2, a die part 640 that serves as a passage through which the embossing punch part 620 moves to the object, and a blank holder 660 that comes into being opposed to the embossing punch part 620 within the die part 640. The recessed part according to the present embodiment is a part punched along the edge of the embossing punch part, and the embossed part may have an inner circular shape and an outer circular shape based on the punched recessed part.

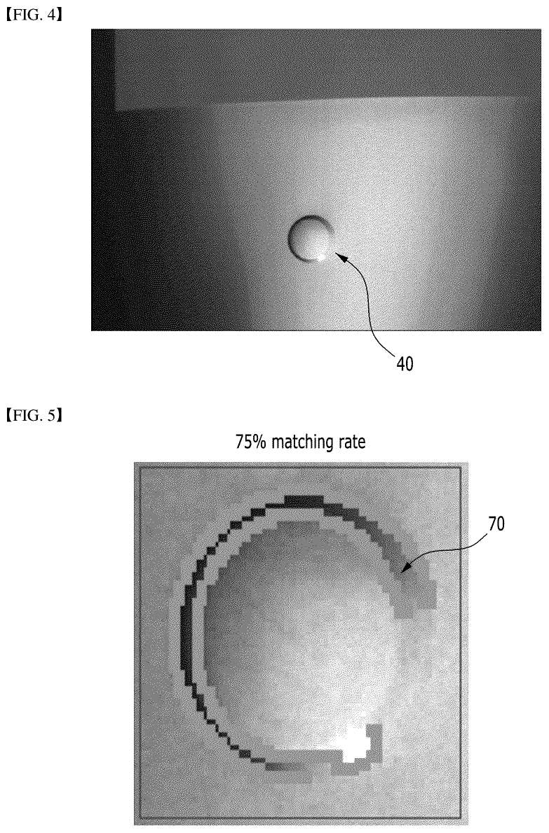

FIG. 4 is a photograph showing an embossing part formed by an embossing process according to a comparative example. FIG. 5 is a view showing a visual recognition rate of the embossing part of FIG. 4. The embossing process according to the comparative example is a case in which the embossing part is formed through the embossing punch part 620 without using the blank holder 660 of FIG. 3.

Referring to FIGS. 4 and 5, in the embossing part 40 according to the comparative example, the bottom surface of the pouch film can be stretched and project upward in a convex shape in the process of forming the recessed part 70. When the bottom surface of the pouch film becomes convex upward in this way, a shadow is generated when the embossing part is subjected to visual recognition, and the visual recognition rate is lowered, so that a matching rate with the pre-stored standard may be reduced as shown in FIG. 5.

Further, since the embossing punch part descends from an empty space inside the die part 640 of FIG. 3 to form a recessed part, there is a possibility that the embossing punch part does not come down in a straight manner and is biased to one side. Accordingly, the recessed part may be unclearly formed, and thus the visual recognition rate may be reduced.

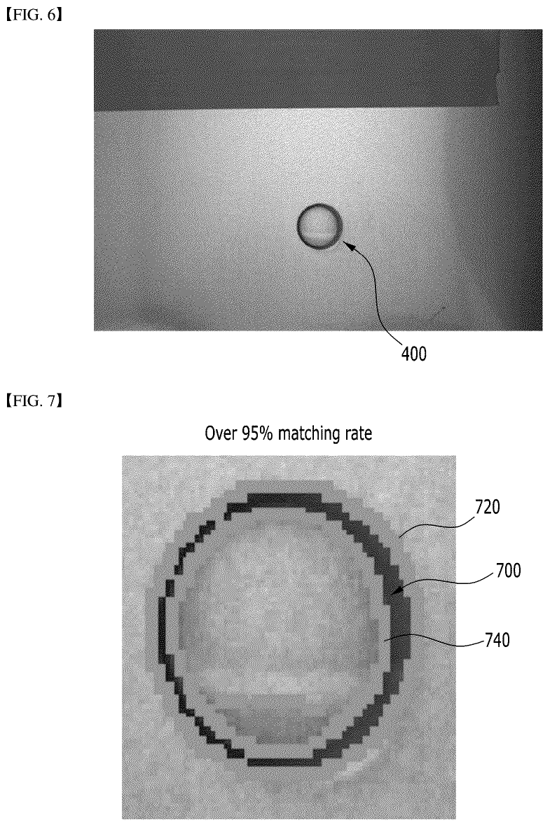

FIG. 6 is a photograph showing an embossing part formed by an embossing process according to an embodiment of the present disclosure. FIG. 7 is a view showing a visual recognition rate of the embossing part of FIG. 6.

Referring to FIGS. 6 and 7, the embossing part 400 according to the present embodiment may be in a state where the blank holder presses the bottom surface of the pouch film in the process where the embossing punch part forms the recessed part 700. Further, in the step of forming the embossing part 400, the embossing punch part may come down toward the pouch film in a state where the embossing punch part and the blanking holder are opposed to each other according to the vertical direction to a direction which the embossing punch part come down, within the die part 640. In this manner, since the blank holder presses the bottom surface of the embossing part 400 in the process of forming the recessed part 700, it is possible to prevent the bottom surface of the pouch film from being stretched and protruding upward in a convex shape. That is, the bottom surface of the embossed part 400 can be formed to be flat. Therefore, in the embossing part 400 according to the present embodiment, an inner circular shape 740 and an outer circular shape 720 are clearly appeared based on the punched recessed part 700. At this time, when the recessed part 700 is subjected to vison inspection, it is clearly recognized, and the matching rate with the pre-stored standard may appear very high. Further, since the embossing punch part descends from an empty space inside the die part 640 of FIG. 3, in a state where the embossing punch part and the blanking holder are opposed to each other within the die part 640 to form a recessed part, it is unlikely that the embossing punch part does not come down in a straight manner and is biased to one side. Accordingly, the recessed part may be clearly formed, and thus the vision recognition rate may be increased.

Although the invention has been shown and described above with reference to the preferred embodiments, the scope of the present disclosure is not limited thereto, and numerous other modifications and improvements devised by those skilled in the art using the basic principles of the invention described in the appended claims will fall within the spirit and scope of the present disclosure.

### DESCRIPTION OF REFERENCE NUMERALS

400: embossing part
10 600: embossing punch unit
620: embossing punch part
640: die part
660: blank holder
700: recessed part

1. A method of manufacturing a pouch type battery cell, comprising:
forming an embossing part in a part of a pouch film by using an embossing punch part.

2. The method of manufacturing a pouch type battery cell according to claim 1, wherein:
the embossing punch part is punched along an edge of the embossing part to form a recessed part.

3. The method of manufacturing a pouch type battery cell according to claim 1, wherein:
the embossing part is subjected to visual recognition as an inner circular shape and an outer circular shape based on the punched recessed part.

4. The method of manufacturing a pouch type battery cell according to claim 1, wherein:
the forming the embossing part further comprises processing a pouch film in a state where the embossing punch part and a blank holder are opposed to each other within a die part serving as a passage through which the embossing punch part moves.

5. The method of manufacturing a pouch type battery cell according to claim 4, wherein:
the forming the embossing part further comprises punching the pouch film by the embossing punch part while the blank holder presses a bottom surface of the pouch film in contact with the embossing punch part.

6. The method of manufacturing a pouch type battery cell according to claim 5, wherein:
a bottom surface of the embossing part is formed to be flat.

7. The method of manufacturing a pouch type battery cell according to claim 1, wherein:
the embossing part is formed during formation of a pouch from the pouch film of the pouch type battery cell.

8. A pouch forming apparatus for forming a receiving part of a pouch film, the apparatus comprising:
an embossing punch part;
a die part serving as a passage through which the embossing punch part moves; and
a blank holder opposed to the embossing punch part with in the die part.

9. The pouch forming apparatus according to claim 8, wherein:
the embossing punch part forms an embossing part having a recessed part in the pouch film, and
the embossing punch part has an outer circular shape and an inner circular shape of the embossing part are formed by the recessed part.

10. The pouch forming apparatus according to claim 9, wherein:
the blank holder presses a bottom surface of the pouch film in contact with the embossing punch part so that a bottom surface of the embossing part is flat.
